(19) United States
(12) Patent Application Publication
(10) Pub. No.: US 2015/0379843 A1
(43) Pub. Date: Dec. 31, 2015

(54) SIGNAL COMPARISON CONTROL UNIT, ANTI-THEFT ALARM UNIT COMPOSED THEREBY, AND INVISIBLE ELECTRONIC FENCE

(71) Applicants: Zhifeng YE, (US); SHANGHAI LENTONE COMMUNICATION TECHNOLOGY CO., LTD., Shanghai (CN)

(72) Inventors: Zhifeng YE, Shanghai (CN); He YANG, Shanghai (CN)

(73) Assignees: Zhifeng YE, Shanghai (CN); SHANGHAI LENTONE COMMUNICATION TECHNOLOGY CO., LTD., Shanghai (CN)

(21) Appl. No.: 14/765,635

(22) PCT Filed: Nov. 19, 2013
(86) PCT No.: PCT/CN2013/087446

§ 371 Date: Aug. 4, 2015

(30) Foreign Application Priority Data
Feb. 5, 2013 (CN) 201310045828.4

(51) Int. Cl. G08B 13/24; G08B 13/16; G08B 13/184

(52) U.S. Cl. CPC G08B 13/2494; G08B 13/184; G08B 13/1618

(57) ABSTRACT

A signal comparison and control unit including: a pre-processing module, pre-processing input signals to conform to processing requirements of a comparison module; the comparison module, comparing pre-set base signal parameters with output signal parameters from the pre-processing module and outputting a comparison result to a decision module; the decision module, with triggering conditions being preset, triggering output of electric signals or comparison data when the comparison result output by the signal comparison module matches the triggering conditions. Also an intrusion alarming unit and an invisible electronic fence constructed from the signal comparison and control unit. The signal comparison and control unit are capable of reducing false alarms.

### FIELD OF INVENTION

The present invention relates to the field of security safeguard, and in particular relates to a signal comparison and control unit. The present invention also relates to an intrusion alarming unit and an invisible electronic fence constructed from the signal comparison and control unit.

### BACKGROUND ART

Nowadays, installation of an invisible electronic fence is a must of security safeguard for residential quarters and such like areas and bases. Depending on whether a physical fence is installed or not, an electronic fence providing intrusion alarm service to a specific area is categorized as visible or invisible. The visible electronic fence comprises a physical fence and a tension and pulse detecting device, wherein the tension and pulse detecting device transforms an intrusion signal detected on the physical fence to an electronic signal to decide if there is an intrusion act. On the other hand, the invisible electronic fence has no physical fence, and is further divided into a passive infrared detector installed indoors and an active infrared intrusion detector installed outdoors. It decides if there is an intrusion act according to a signal break on the infrared signal. An invisible electronic fence provides an area-encompassing intrusion protection alarm service for a specific region (i.e., an intrusion alarm region, its boundary variable depending on the area covered by the signal of the invisible electronic fence).

An active infrared intrusion detector has a basic structure comprising a transmitting terminal, a receiving terminal, a ray intensity indicator, and an optical lens. Its detecting principle is that an infrared LED emitting diode transmits a pulse infrared light which is focused in an optical minor for long distance transmission and is to be received by an optical receiver. If the infrared pulse light is blocked, an alarm will ring. Infrared light is invisible and is dispersive. Subsequent to its transmission, a ray cone will come into being at its initial path, with its ideal intensity being in an inverse square attenuation in respect to the transmission distance as the latter increases.

When an object passes over the detected region, it will block the infrared ray and elicit an alarm. Traditional active infrared intrusion detectors are generally employed for outdoor fence alarm. An active infrared intrusion detector has to select a suitable triggering response time: a short response time is prone to cause unwarranted interference, such as the case of a flying bird or a falling leaf; a long one will result in missed alarms. Moreover, an active infrared intrusion detector needs to be installed on either side of a window, a door, or a balcony, with wiring required, which generally necessitates drilling into walls, thus unfavorably affecting the appearance of the building or the dwelling place, and at the mean time resulting in a long project time and high cost and inconvenience to the user.

A passive infrared detector, on the other hand, is comprised of an optical system, a heat sensor (also named infrared pyroelectric sensor) and an alarm controller. The detector itself passively receives and detects infrared radiation around it, without emitting out any energy. At detection of human infrared radiation, which is then focused via the optical system, a break in an electric signal of the pyroelectric device will be generated, thus generating an alarm.

The passive infrared detector solves the problem of difficulty in the installation of the active infrared intrusion detector, while at the mean time brings with it a new issue, that is, its poor stability, high false alarm rate, with the biggest problem being affecting routine life of the indoor inhabitants, their space of activity is reduced, their scope of activity is restricted, and thus becomes an obstacle for usage of the indoor alarm system.

### SUMMARY OF THE INVENTION

The technical problem the present invention aims to solve is to provide a signal comparison and control unit which reduces false alarm rate. The present invention also provides an intrusion alarming unit and an invisible electronic fence constructed from the signal comparison and control unit.

To solve the afore-mentioned technical problem, the signal comparison and control unit of the present invention comprises: a pre-processing module, pre-processing an input signal to conform to processing requirements of a comparison module; the comparison module, comparing pre-set base signal parameters with output signal parameters from the pre-processing module and outputting a comparison result to a decision module; the decision module, with a triggering condition being preset, triggers outputting of data of an electric signal or the comparison result when the comparison result output by the signal comparison module matches the triggering condition.

Furthermore, the input signal is any one, or any multiple, of an infrared signal, a laser signal, a microwave signal, or an ultrasonic signal.

Furthermore, the comparison module compares the preset triggering condition with any parameter or any multiple of parameters of intensity, time, distance, or temperature of the output signal from the pre-processing module.

Furthermore, it further comprises a signal output device which receives, processes and outputs the data of the electric signal and/or the comparison result from the decision module.

Furthermore, the signal output device comprises an electric signal output module and/or a data output module for processing and then outputting respectively the electric signal and/or the comparison result of the decision module.

Wherein, the electric signal output module comprises: a first NMOS diode NM1, with a gate thereof to function as an electric signal output terminal Alarm Out via a first resistor R1, a drain thereof to function as an electric signal input terminal AMO NO via a second resistor R2, and a source thereof to be grounded.

Wherein, the data output module U6 may be a communication interface chip, such as a RS485 interface chip, with a common type thereof being MAX1478.

Wherein, the pre-processing module comprises: an amplifier AR1, an output terminal A thereof functioning as an output terminal RC1 of the pre-processing module via a third resistor R3, an inverse input terminal − thereof being connected to a drain of a second NMOS diode NM2, a forward input terminal + thereof being connected to a second control terminal C thereof via a fourth resistor R4, and being connected to the output terminal RC1 of the pre-processing module via a fifth resistor R5; a first control terminal B thereof is connected with an end respectively of a sixth resistor R6, a seventh resistor R7, an eighth resistor R8, and a ninth resistor R9; a second control terminal C thereof is connected with a tenth resistor R10, an eleventh resistor R11, the source of the second NMOS diode NM2, and a positive pole of a first photodiode D1; the other end of the sixth resistor R6 and that of the tenth resistor R10 are connected with a negative pole of the first photodiode D1, the other end of the seventh resistor R7 and that of the eleventh resistor R11 are connected with the gate of the first NMOS diode NM1 via a twelfth resistor R12, the other end of the eighth resistor R8 is connected with the drain of the second NMOS diode NM2, and the other end of the ninth resistor R9 is connected with the forward input terminal + of the amplifier AR1; the drain of the second NMOS diode NM2 is connected with the negative pole of the first photodiode D1 via a second capacitor C2; a first capacitor C1 is parallel connected with the two ends of the eleventh resistor R11, and a third capacitor C3 is parallel connected with the two ends of the third resistor R3.

Furthermore, the comparison module or the decision module is either a single chip or a logic circuit.

An intrusion alarming unit, employed for generating an intrusion alarm in a specific region, comprises any of the afore-mentioned signal comparison and control units; it further comprises: a signal generating unit, for generating a detection signal, and being connected with the comparison module of the signal comparison and control unit to provide the base signal parameters for the comparison module; a signal induction unit, connected with the pre-processing module of the signal comparison and control unit, and providing the input signal for the pre-processing module; further, the signal induction unit and the signal generating unit are correspondingly arranged and combined as a pair for receiving the detection signal; the signal generating unit and the signal induction unit are located at a same side of the specific region, and are integratable in a main-board.

Wherein, the signal generating unit comprises: an emitting photodiode LED1, a positive pole thereof is grounded via a thirteenth resistor R13 and a fourth capacitor C4, a negative pole thereof is connected with a drain of a third NMOS diode NM3; the third NMOS diode NM3 has a gate thereof connected with DR1 (a driver) via a fourteenth resistor r14, and a source thereof grounded.

Furthermore, the signal generating unit and the signal induction unit transmits and receives any or any multiple of signals of an infrared signal, a laser signal, a microwave signal, or an ultrasonic signal.

Furthermore, a transmitting signal of the signal generating unit covers an area within a same physical plane from 0 to 360 degrees; preferably, the covered area ranges from 0 to 180 degrees.

Furthermore, it comprises at least two groups of signal generating unit and signal induction unit arranged correspondingly at the same side of the specific region; preferably, the number of groups of signal generating unit and signal induction unit is 2-6.

Furthermore, the decision module decides on an intrusion direction in accordance with a changing trend of the comparison result output by the comparison module.

Furthermore, the decision module of the signal generating unit sets the triggering condition in accordance with the intrusion direction.

An invisible electronic fence, comprising at least one of the afore-mentioned intrusion alarming units of any claim of claims 7-10, further comprises a controlling and processing module which is connected with the signal output device, the signal comparison and control unit, the signal generating unit and the signal induction unit, and which controls the signal output device, the signal comparison and control unit, the signal generating unit and the signal induction unit.

Wherein, the controlling and processing module is a single chip U1, a sixth terminal XT2 and a seventh terminal XT1 thereof are grounded via respectively a fifth capacitor C5 and a sixth capacitor C6, and are connected with a crystal CY1; a third terminal RST thereof is grounded via a fifteen resistor R15, and is connected to a power voltage via a seventh capacitor C7; furthermore, it further comprises a signal enhancing unit, for receiving a controlling signal of the controlling and processing module and adjusting a parameter of a generating signal of the signal generating unit.

Furthermore, it further comprises a signal reflecting unit, for reflecting the signal generated by the signal generating unit to the signal induction unit.

Furthermore, it further comprises a solar power unit, for supplying power to each component of the invisible electronic fence.

Furthermore, it further comprises a display unit, for displaying alarm messages from the controlling and processing module.

Furthermore, the display unit is wireless connected with the controlling and processing module.

Furthermore, the controlling and processing module is connected via wireless communication with the signal output device, the signal comparison and control unit, the signal generating unit and the signal induction unit.

The signal induction unit provided by the present invention pre-processes the input signal via the pre-processing module, and compares, via the comparison module, the base signal parameters with the output signal parameters from the pre-processing module; it then compares the comparison result output by the signal comparison module with the preset triggering condition and makes a decision via the decision module, and it triggers outputting of an enabling signal or the comparison result when the triggering condition is matched. The input signal of the present invention is any or any multiple of an infrared signal, a laser signal, a microwave signal, or an ultrasonic signal and is capable of comparing the preset triggering condition with any or any multiple of parameters of intensity, time, distance, or temperature of the output signal from the pre-processing module, and triggers an output (data of an enabling signal or the comparison result); by properly selecting input signals and setting the comparison parameters of the comparison module in accordance with the actual usage milieu, false alarms can be reduced to the best extent, thus lowering false alarm rate.

The intrusion alarming unit, employed for generating an intrusion alarm in a specific region, comprises the afore-mentioned signal comparison and control unit; it further comprises: a signal generating unit, for generating a detection signal and providing the base signal parameters for the comparison module; a signal induction unit, for receiving the detection signal; it is connected with the pre-processing module linked with the signal comparison and control unit, and provides input signals for the pre-processing module; the signal generating unit and the signal induction unit are located at the same side of the specific region, and there might be more than one group of signal generating unit and signal induction unit arranged correspondingly; the surroundings may act as a reflecting unit for the detection signal, or there may be specially arranged a signal reflecting unit (the latter is the common scenario); the intrusion alarming unit of the present invention arranges more than two groups of signal generating unit and signal induction unit, and decides on an intrusion direction via a changing trend of the detection signal; for example, the detection signal received by the induction unit might undergo successively a change in intensity (decrease/increase), time (signal delay increases or decreases), distance, and temperature. The intrusion alarming unit provided by the present invention sets the triggering condition in accordance with the intrusion direction so as to reduce false alarm rate.

The invisible electronic fence as provided by the present invention arranges the signal generating unit and the signal induction on the same side of the specific region, has the recourse of the nearby buildings or landscapes for signal reflection (a preferred embodiment might set a reflecting unit to correspond to the signal generating unit and the signal induction unit), and controls the signal comparison and controls unit, the signal generating unit and the signal induction unit via the controlling and processing module, and thus has a simple structure and is easily installed. At the mean time, the invisible electronic fence of the present invention adopts the active detection mode, and with recourse to the signal comparison and control unit provided by the present invention, it reduces false alarm rate and operates in a stable manner.

### BRIEF DESCRIPTION OF THE DRAWINGS

In combination with the drawings hereunder provided, the present invention will be further expounded in details:

FIG. 1 is a schematic diagram of the first embodiment of the signal comparison and control unit of the present invention.

FIG. 2 is a schematic diagram of the first embodiment of the pre-processing module of the present invention.

FIG. 3 is a schematic diagram of the second embodiment of the signal comparison and control unit of the present invention.

FIG. 4 is a schematic diagram of the third embodiment of the signal comparison and control unit of the present invention.

FIG. 5 is a schematic diagram of the first embodiment of the electric signal output module of the present invention.

FIG. 6 is a schematic diagram of the first embodiment of the intrusion alarming unit of the present invention.

FIG. 7 is a schematic diagram of the first embodiment of the signal generating unit of the present invention.

FIG. 8 is a schematic diagram of the second embodiment of the intrusion alarming unit of the present invention.

FIG. 9 is a schematic diagram of the first embodiment of the invisible electronic fence of the present invention.

FIG. 10 is a schematic diagram of an embodiment of the controlling and processing module of the present invention.

FIG. 11 is a schematic diagram of the second embodiment of the invisible electronic fence of the present invention.

FIG. 12 is a schematic diagram of the fourth embodiment of the invisible electronic fence of the present invention.

FIG. 13 is a schematic diagram of the fifth embodiment of the invisible electronic fence of the present invention.

FIG. 14 is a schematic diagram for the installation of the invisible electronic fence of the present invention.

FIG. 15 is another schematic diagram for the installation of the invisible electronic fence of the present invention.

### DETAILED DESCRIPTION

It warrants an explanation that the electronic fence of the present invention does not include a physical fence or a tension and pulse detection device. Instead, it decides if there is an intrusion act in accordance to a break on the reflection signal, and is therefore named an invisible electronic fence.

A first embodiment of a comparison and control unit, as is shown on FIG. 1, includes: a pre-processing module 1, pre-processing an input signal to conform to processing requirements of a comparison module; wherein the input signal is any one, or any multiple, of an infrared signal, a laser signal, a microwave signal, or an ultrasonic signal; a comparison module 2, comparing pre-set base signal parameters (the base signal parameters may either be preset, or be provided by another device) with output signal parameters from the pre-processing module 1 and outputting a comparison result to a decision module 3; the comparison module 2 compares the preset triggering condition with any parameter or any multiple of parameters of intensity, time, distance, or temperature of the output signal from the pre-processing module 1; a decision module 3, with a triggering condition being preset, triggers outputting of data of an electric signal or the comparison result when the comparison result output by the comparison module 2 matches the triggering condition.

Wherein, for simplification or for the sake of low cost, the comparison module 2 or the decision module 3 may both be implemented by a single chip or a logic circuit. In such a case, distance measuring precision will be substantially reduced.

As is shown on FIG. 2, a first embodiment of the pre-processing module 1 of the present invention includes: an amplifier AR1, with an output terminal A thereof functioning as an output terminal RC1 of the pre-processing module via voltage division by a third resistor R3 and a fifth resistor R5, with an inverse input terminal − thereof being connected to a drain of a second NMOS diode NM2, and with a forward input terminal + thereof being connected to a second control terminal C (power reference grounding) thereof via a fourth resistor R4; wherein, an output terminal A thereof functioning as an output terminal RC1 of the pre-processing module via the third resistor R3, the inverse input terminal − thereof being connected to a drain of a second NMOS diode NM2, the forward input terminal + thereof being connected to a second control terminal C thereof via a fourth resistor R4, and being connected to the output terminal RC1 of the pre-processing module via the fifth resistor R5; a first control terminal B thereof is connected with an end respectively of a sixth resistor R6, a seventh resistor R7, an eighth resistor R8, and a ninth resistor R9; a second control terminal C thereof is connected with a tenth resistor R10, an eleventh resistor R11, the source of the second NMOS diode NM2, and a positive pole of a first photodiode D1; the other end of the sixth resistor R6 and that of the tenth resistor R10 are connected with an negative pole of the first photodiode D1, the other end of the seventh resistor R7 and that of the eleventh resistor R11 are connected with the gate of the first NMOS diode NM1 via a twelfth resistor R12, the other end of the eighth resistor R8 is connected with the drain of the second NMOS diode NM2, and the other end of the ninth resistor R9 is connected with the forward input terminal +of the amplifier AR1; the drain of the second NMOS diode NM2 is connected with the negative pole of the first photodiode D1 via a second capacitor C2; a first capacitor C1 is parallel connected with the two ends of the eleventh resistor R11, and a third capacitor C3 is parallel connected with the two ends of the third resistor R3.

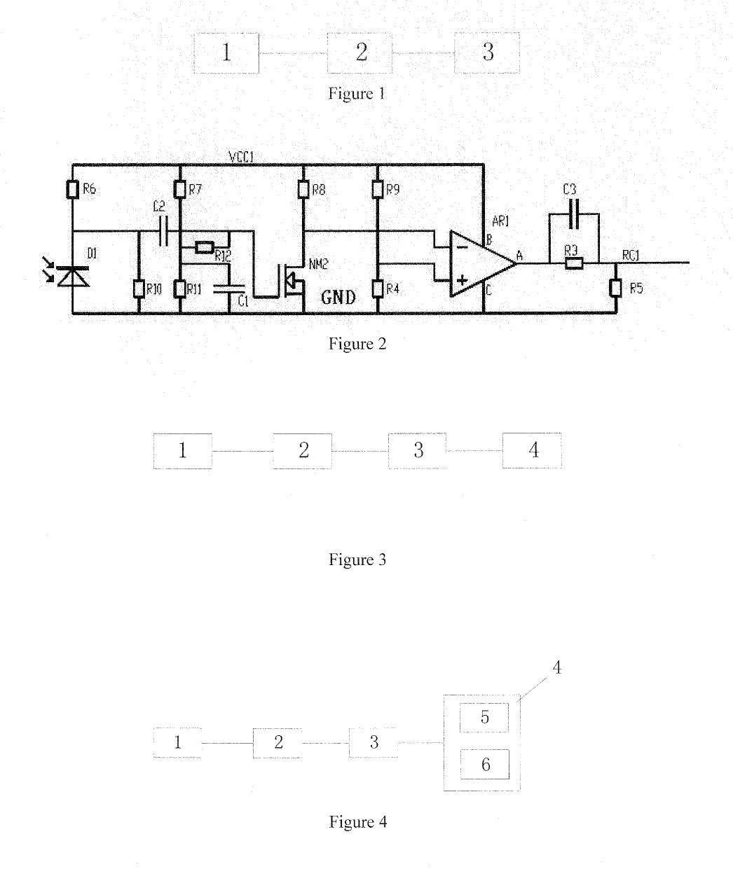

As is shown on FIG. 3, the signal comparison and control unit of the present invention furthermore includes a signal output device 4 which receives, processes and outputs the data of the electric signal and/or the comparison result from the decision module 3.

A third embodiment of the signal comparison and control unit of the present invention is shown on FIG. 4, wherein the signal output device thereof includes an electric signal output module 5 and a data output module 6, for processing and then outputting respectively the electric signal and the comparison result of the decision module 3. Wherein, the data output module 6 might adopt a U6 (a logic combination of CPLD (complex programmable logic device)/FPGA (field programmable gate arrays)/ASIC (application specific integrated circuit)); wherein, the pre-processing module 1 in the embodiment adopts the structure of the first embodiment of the pre-processing module 1, while the electric signal output module 5 adopts the structure of the first embodiment of the electric signal output module 5.

As is shown on FIG. 5, a first embodiment of the electric signal output module 5 of the present invention includes: a first NMOS diode NM1, with a gate thereof to function as an electric signal output terminal Alarm Out via a first resistor R1, a drain thereof to function as an electric signal input terminal AMO NO via a second resistor R2, and a source thereof to be grounded.

The signal comparison and control unit might only include either one of the electric signal output module 5 or the data output module 6, as in similar cases hereunder, and the statement will not be repeated again.

An intrusion alarming unit of the present invention, employed for intrusion alarming in a specific region, includes any one of the afore-mentioned embodiments of the signal comparison and control unit.

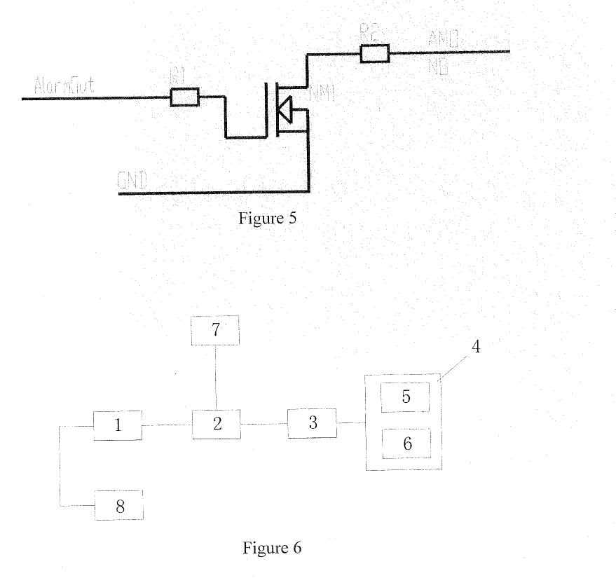

As is shown on FIG. 6, a first embodiment of the intrusion alarming unit of the present invention includes the third embodiment of the signal comparison and control unit; it further includes: a signal generating unit 7, for generating a detection signal, and is connected with the comparison module 2 of the signal comparison and control unit to provide the base signal parameters for the comparison module 2; a signal induction unit 8, connected with the pre-processing module 1 of the signal comparison and control unit, and providing the input signal for the pre-processing module 1; further, the signal induction unit and the signal generating unit are correspondingly arranged and combined as a device for receiving the detection signal; wherein, the signal generating unit 7 and the signal induction unit 8 are located at a same side of the specific region, and are integratable in a main-board.

Wherein, a transmitting signal of the signal generating unit 7 covers an area within a same physical plane from 0 to 360 degrees; preferably, the covered area ranges from 0 to 180 degrees.

Wherein, the signal generating unit 7 and the signal induction unit 8 transmits and receives any or any multiple of signals of an infrared signal, a laser signal, a microwave signal, or an ultrasonic signal.

The intrusion alarming unit of the present invention includes at least two groups of the signal generating unit 7 and the signal induction unit 8 arranged correspondingly at the same side of the specific region; preferably, the number of groups of the signal generating unit 7 and the signal induction unit 8 is 2-6.

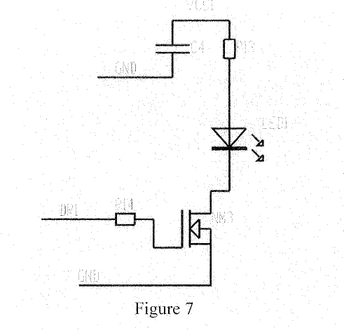

As is shown on FIG. 7, a first embodiment of the signal generating unit 7 includes: an emitting photodiode LED1, a positive pole thereof is grounded via a thirteenth resistor R13 and a fourth capacitor C4, a negative pole thereof is connected with a drain of a third NMOS diode NM3; the third NMOS diode NM3 has a gate thereof connected with DR1 via a fourteenth resistor r14, and a source thereof grounded.

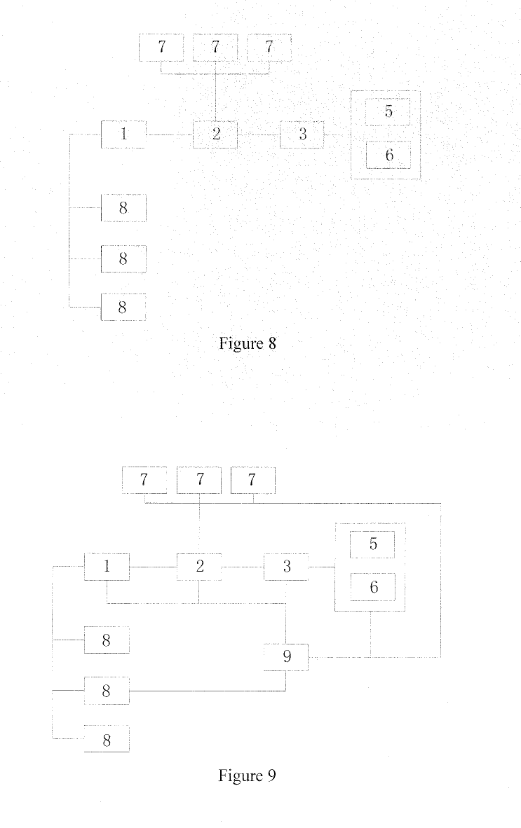

A second embodiment of the intrusion alarming unit of the present invention includes, as is shown on FIG. 8, differs from the first embodiment of the intrusion alarming unit of the present invention in that it has 3 groups of the signal generating unit 7 and the signal induction unit 8 arranged correspondingly at the same side of the specific region.

Furthermore, by means of setting 3 groups of the signal generating unit 7 and the signal induction unit 8, an intrusion direction can be decided on according to a changing trend of a parameter of the detection signal; as an example, the detection signals received by the 3 signal induction units 8 undergo successively a change in intensity (decrease/increase), time (signal delay increases or decreases), distance, and temperature; the decision module 3 then decides on the intrusion direction according to the comparison result output by the comparison module 2.

Furthermore, the decision module 3 of the signal comparison and control unit may set the triggering condition in accordance with the intrusion direction; for example, a specific intrusion direction may be set not to elicit an alarm, or another intrusion direction may be set to disregard a first intrusion and only sound an alarm on a second one.

The intrusion acts of the intrusion alarming unit of the present invention may be categorized into multiple types, such as: intrusion by a flying bird, blocking of a door or a window, and intrusion by an intruder. The decision module then decides on an alarming signal of a specific level in accordance with the preset conditions. By means of such active detection and by carefully differentiating on the differences of the reflecting signals sent and received, such intrusions as a flying bird or a blocking door or window can be ignored, and the false alarm rate is thus substantially reduced.

An invisible electronic fence, comprising at least one of the afore-mentioned intrusion alarming units, further includes a controlling and processing module 9 which is connected with the signal output device 4, the signal comparison and control unit, the signal generating unit 7 and the signal induction unit 8, and which controls the signal output device 4, the signal comparison and control unit, the signal generating unit 7 and the signal induction unit 8.

As is shown on FIG. 9, a first embodiment of the invisible electronic fence of the present invention includes the second embodiment of the intrusion alarming unit, the controlling and processing module 9 thereof is connected with the signal output device 4, the pre-processing module 1, the comparison module 2, the decision module 3 of the signal comparison and control unit, the signal generating unit 7 and the signal induction unit 8, and controls the signal comparison and control unit and the signal generating unit 7 and the signal induction unit 8. For example, the controlling and processing module 9 is capable to control the pre-processed parameter of the input signal (i.e., the returned detection signal received by the induction unit 8), is capable to control the setting of the base signal parameters in the comparison module 2, is capable to decide on the triggering condition of the decision module 3 and to compulsorily shut off output of the decision module when the triggering condition is matched, is capable to control if the data output device outputs an electric signal or a comparison result, is capable to control the types and parameters of the detection signal transmitted by the signal generating unit 7, and is capable to control whether the induction unit 8 receives the returned detection signal.

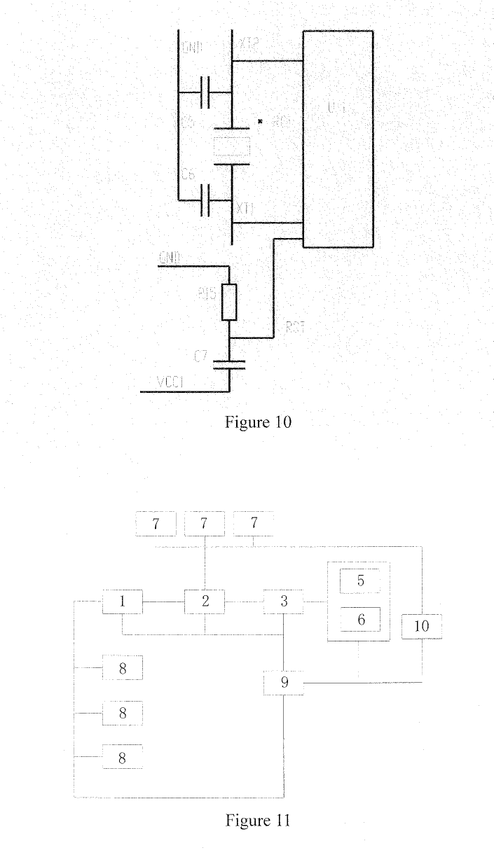

An embodiment of the controlling and processing module of the present invention is shown on FIG. 10, which is a single chip U1 (a high-speed mcs-51 series single chip), a sixth terminal XT2 and a seventh terminal XT1 thereof are grounded via respectively a fifth capacitor C5 and a sixth capacitor C6, and are connected with a crystal CY1; a third terminal RST thereof is grounded via a fifteen resistor R15, and is connected to a power voltage via a seventh capacitor C7.

A second embodiment of the invisible electronic fence of the present invention is shown on FIG. 11. It further includes a signal enhancing unit 10, for receiving a controlling signal of the controlling and processing module 9 and adjusting a parameter of a generating signal of the signal generating unit 7.

Furthermore, it further includes a signal reflecting unit, for reflecting the signal generated by the signal generating unit to the signal induction unit.

A third embodiment of the invisible electronic fence of the present invention, further includes a signal reflecting unit on the basis of the second embodiment of the invisible electronic fence of the present invention, which is arranged on the other side (opposite to the location of the intrusion alarming unit) of the specific region, for reflecting the detection signal generated by the signal generating unit 7 to the signal induction unit 8.

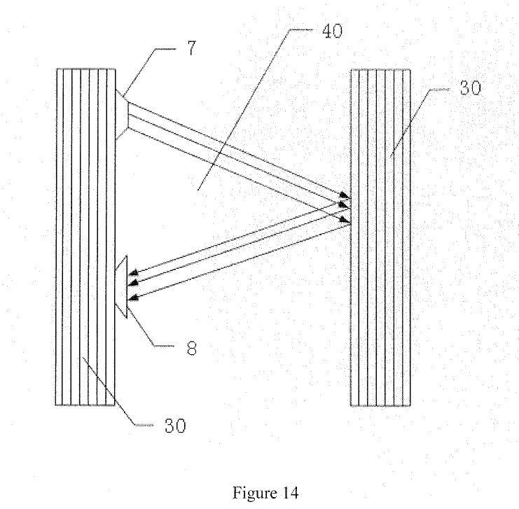

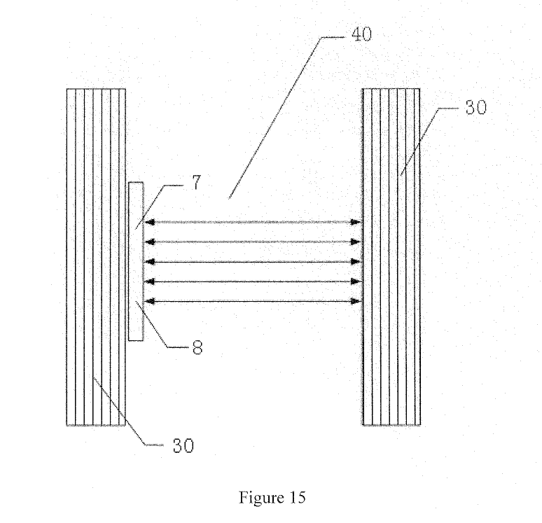

The signal reflecting unit 11 can be installed according to FIG. 14 or FIG. 15, wherein the location opposite to the wall 30 may be selected as the reflecting unit 11.

As is shown on FIG. 14, the signal generating unit 7 and the signal induction unit 8 are separated.

As is shown on FIG. 15, the signal generating unit 7 and the signal induction unit 8 are fabricated on a main-board (a PCB).

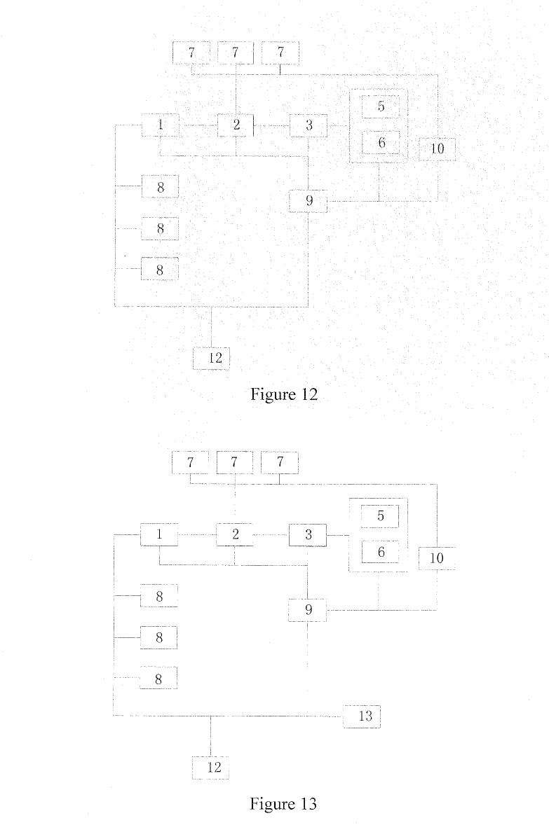

As is shown on FIG. 12, a fourth embodiment of the invisible electronic fence of the present invention, further includes a solar power unit 12, on the basis of the second embodiment of the invisible electronic fence of the present invention, for supplying power to each component of the invisible electronic fence.

As is shown on FIG. 13, a fifth embodiment of the invisible electronic fence of the present invention, further includes a display unit 13, on the basis of the fourth embodiment of the invisible electronic fence of the present invention, for displaying alarm messages from the controlling and processing module 9;

wherein, the display unit 13 may be wireless connected with the controlling and processing module 9;

wherein, the controlling and processing module 9 is connected via wireless communication with the signal output device 4, the signal comparison and control unit, the signal generating unit 7 and the signal induction unit 8.

The present invention has thus been fully enunciated with the fore-going embodiments, but is not meant to be limited thereby. Any alteration or improvement made by a person of the art, without departing from the principle of the present invention, shall fall within the scope of the present invention.

### DESCRIPTION OF THE REFERENCE SIGNS OF THE DRAWINGS

1 stands for the pre-processing module,

2 stands for the comparison module,

3 stands for the decision module,

4 stands for the output device,

5 stands for the electric signal output module,

6 stands for the data output module,

7 stands for the signal generating unit,

8 stands for the signal induction unit,

9 stands for the controlling and processing module,

10 stands for the signal enhancing unit,

11 stands for the signal reflecting unit,

12 stands for the solar power unit,

13 stands for the display unit,

30 stands for the wall,

40 stands for the region in-between two walls 30,

R1-R5 stands each for a resistor respectively,

C1-C7 stands each for a capacitor respectively,

AR1 stands for the amplifier,

A stands for the output terminal of AR1,

B stands for the first control terminal of AR1,

C stands for the second control terminal of AR1,

D1 stands for the photodiode,

LED1 stands for the emitting photodiode,

NM1-NM3 stands each for an NMOS diode,

CY1 stands for the crystal,

RC1 stands for the output terminal of the pre-processing module,

DR1 stands for the driver terminal,

GND stands for grounding,

Alarm Out stands for electric signal driving

AMO NO stands for the output terminal of the electric signal,

U1 stands for the single chip,

RST stands for the reset input port of the U1,

XT2 stands for a crystal interface of the U1,

XT1 stands for a crystal interface of the U1,

VCC1 and VCC stand each for a power source.

1-14. (canceled)

15. A signal comparison and control unit comprising:
a pre-processing module, pre-processing an input signal to conform to processing requirements of a comparison module;
the comparison module, comparing pre-set base signal parameters with output signal parameters from the pre-processing module and outputting a comparison result to a decision module; and
the decision module, with a triggering condition being preset, triggering outputting of data of an electric signal or the comparison result at matching the triggering condition by the comparison result output by the signal comparison module.

16. The signal comparison and control unit of claim 15, wherein the input signal is any one, or any multiple, of an infrared signal, a laser signal, a microwave signal, or an ultrasonic signal.

17. The signal comparison and control unit of claim 16, wherein the comparison module compares the preset triggering condition with any parameter or any multiple of parameters of intensity, time, distance, or temperature of the output signal from the pre-processing module.

18. The signal comparison and control unit of claim 17, wherein it further comprises a signal output device, and the signal output device receives, processes and outputs the data of the electric signal and/or the comparison result from the decision module.

19. The signal comparison and control unit of claim 15, wherein the comparison module or the decision module is either a single chip or a logic circuit.

20. An intrusion alarming unit, employed for generating an intrusion alarm in a specific region and comprising the signal comparison and control unit claim 15, wherein:
it further comprises: a signal generating unit, for generating a detection signal, and being connected with the comparison module of the signal comparison and control unit to provide the base signal parameters for the comparison module, and
a signal induction unit, connected with the pre-processing module of the signal comparison and control unit, and providing the input signal for the pre-processing module; further, the signal induction unit is correspondingly arranged with the signal generating unit to combine as a pair for receiving the detection signal;
the signal generating unit and the signal induction unit are located at a same side of the specific region, and are integratable in a main-board.

21. The intrusion alarming unit of claim 20, wherein the decision module decides on an intrusion direction in accordance with a changing trend of the comparison result output by the comparison module.

22. The intrusion alarming unit of claim 21, wherein the decision module of the signal generating unit sets the triggering condition in accordance with the intrusion direction.

23. The intrusion alarming unit of claim 22, wherein a transmitting signal of the signal generating unit covers an area within a same physical plane from 0 to 360 degrees.

24. The intrusion alarming unit of claim 23, wherein the transmitting signal of the signal generating unit covers an area within a same physical plane from 0 to 180 degrees.

25. The intrusion alarming unit of claim 23, wherein it comprises at least two groups of signal generating unit and signal induction unit arranged correspondingly at the same side of the specific region; preferably, the number of groups of signal generating unit and signal induction unit is 2-6.

26. An invisible electronic fence, comprising at least one intrusion alarming unit of claim 21, wherein it further comprises a controlling and processing module which is connected with the signal output device, the signal comparison and control unit, the signal generating unit and the signal induction unit, and which controls the signal output device, the signal comparison and control unit, the signal generating unit and the signal induction unit.

27. The invisible electronic fence of claim 26, wherein it further comprises a signal enhancing unit, for receiving a controlling signal of the controlling and processing module and adjusting a parameter of a generating signal of the signal generating unit.

28. The invisible electronic fence of claim 27, wherein it further comprises a signal reflecting unit, for reflecting the signal generated by the signal generating unit to the signal induction unit.

29. The invisible electronic fence of claim 27 wherein the controlling and processing module is connected via wireless communication with the signal output device, the signal comparison and control unit, the signal generating unit and the signal induction unit.
